(19) United States
(12) Patent Application Publication
(10) Pub. No.: US 2009/0251370 A1
(43) Pub. Date: Oct. 8, 2009

(54) Apparatus, method, computer program product and computer program distribution medium

(75) Inventors: Thomas Hohne, Helsinki (FI); Ville Ranki, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/155,216

(22) Filed: May 30, 2008

(30) Foreign Application Priority Data
Apr. 3, 2008 (FI) 20085279

(51) Int. Cl. H01Q 3/00

(52) U.S. Cl. 342/377; 342/368

(57) ABSTRACT

The invention is related to an apparatus comprising: at least one generator configured to provide a plurality of signals comprising at least partially correlated noise; and a circuitry configured to convey the signals comprising at least partially correlated noise to a plurality of nonadjacent antenna array elements.

### FIELD

The invention relates to an apparatus, method, computer program product and computer program distribution medium.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

When adaptive antenna arrays are used, the basic principle is that radiation beams are narrow and they are directed as directly as possible at a desired receiver. Widely known methods of using adaptive antenna arrays can be divided into two main groups: radiation beams are directed at a receiver, or the most suitable beam is selected from various alternative beams. The reuse of frequencies can be made more efficient and the power of transmitters can be reduced, because, owing to the directivity of antenna beams, interference with other users diminishes.

### BRIEF DESCRIPTION

According to an aspect of the present invention, there is provided an apparatus, comprising: at least one generator configured to provide a plurality of signals comprising at least partially correlated noise, and a circuitry configured to convey the signals comprising at least partially correlated noise to a plurality of nonadjacent antenna array elements.

According to an aspect of the present invention there is provided a method; comprising: providing a plurality of signals comprising at least partially correlated noise, and conveying the signals comprising at least partially correlated noise to a plurality of nonadjacent antenna array elements.

According to an aspect of the present invention there is provided an apparatus comprising: means for providing a plurality of signals comprising at least partially correlated noise, and means for conveying the signals comprising at least partially correlated noise to a plurality of nonadjacent antenna array elements.

According to an aspect of the present invention there is provided a computer program product encoding a computer program of instructions for executing a computer process, the process comprising: controlling selection of antenna array elements to which the signals comprising at least partially correlated noise are conveyed in a case more antenna array elements are provided than needed for transmission or reception, the selection being made for decreasing effects of noise.

According to an aspect of the present invention there is provided a computer program distribution medium readable by a computer and encoding a computer program of instructions for executing a computer process, the process comprising: controlling selection of antenna array elements to which the signals comprising at least partially correlated noise are conveyed in a case more antenna array elements are provided than needed for transmission or reception, the selection being made for decreasing effects of noise.

### LIST OF DRAWINGS

Embodiments of the present invention are described below, by way of example only, with reference to the accompanying drawings, in which

FIG. 1 illustrates a simplified system architecture;

FIG. 2 shows a simple example of a signal space diagram;

FIGS. 3 and 4 illustrate examples of apparatuses; and

FIG. 5 is a flow chart.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user terminal, server, corresponding component, and/or to any communication system or any combination of different communication systems that support required functionality.

The protocols used, the specifications of communication systems, servers and user terminals, especially in wireless communication, develop rapidly. Such development may require extra changes to an embodiment. Therefore, all words and expressions should be interpreted broadly and they are intended to illustrate, not to restrict, embodiments.

In the following, different embodiments will be described using, as an example of a system architecture whereto the embodiments may be applied, an architecture based on Evolved UMTS terrestrial radio access (E-UTRA, UMTS=Universal Mobile Telecommunications System) without restricting the embodiment to such an architecture, however.

Many different radio protocols to be used in communications systems exist. Some examples of different communication systems are the Universal Mobile Telecommunications System (UMTS) radio access network (UTRAN or E-UTRAN), Long Term Evolution (LTE, the same as E-UTRA), Wireless Local Area Network (WLAN), Worldwide Interoperability for Microwave Access (WiMAX), Bluetooth®, Personal Communications Services (PCS) and systems using ultra-wideband (UWB) technology.

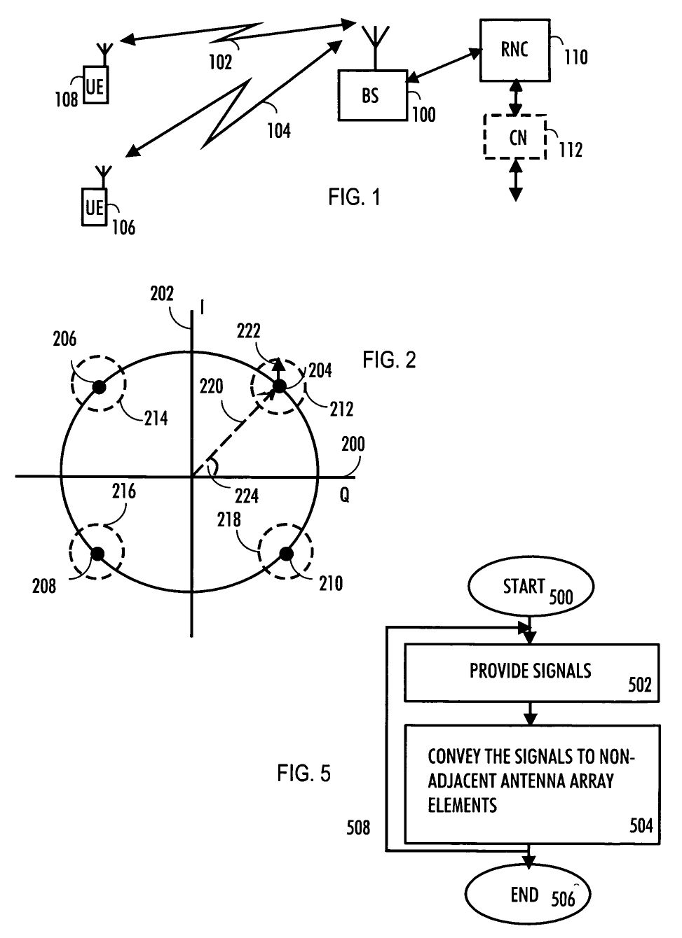

FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

FIG. 1 shows a part of a radio access network of E-UTRA.

The communications system is a cellular radio system which comprises a base station (or node B) 100, which has bidirectional radio links 102 and 104 to user devices 106 and 108. The user devices may be fixed, vehicle-mounted or portable. The user devices 106 and 108 may refer to portable computing devices. Such computing devices include wireless mobile communication devices operating with or without a subscriber identification module (SIM), including, but not limited to, the following types of devices: mobile phone, multimedia device, personal digital assistant (PDA), handset.

The base station includes transceivers, for instance. From the transceivers of the base station, a connection is provided to an antenna unit that establishes bi-directional radio links to the user devices. The base station is further connected to a controller 110, a radio network controller (RNC), which transmits the connections of the devices to the other parts of the network. The radio network controller controls in a centralized manner several base stations connected to it. The radio network controller is further connected to a core network 112 (CN). Depending on the system, the counterpart on the CN side can be a mobile services switching center (MSC), a media gateway (MGW) or a serving GPRS (general packet radio service) support node (SGSN), etc.

It should be noted that in future radio networks, the functionality of an RNC may be distributed among (possibly a subset of) base stations.

The embodiments are not, however, restricted to the system given as an example but a person skilled in the art may apply the solution to other communication systems provided with the necessary properties. Different radio protocols may be used in the communication systems in which embodiments of the invention are applicable. The radio protocols used are not relevant regarding the embodiments of the invention.

The communication system is also able to communicate with other networks, such as a public switched telephone network or the Internet.In the following, direct beamforming is shortly described.

In a digital system, the directing of antenna beams in the up-link is typically implemented by dividing a signal in baseband parts into I and Q branches and by multiplying in a complex manner (phase and amplitude) the signal of each antenna element by appropriate weighting coefficients, and then by summing up the output signals of all antenna elements. In this case, an adaptive antenna array comprises not only antennas but also a signal processor, which automatically adapts antenna beams by using a control algorithm so that in the downlink, it turns the antenna beams in to a direction in which the strongest signal is measured in the uplink. The directivity of beams can also be implemented analogically by using fixed phasing circuits (Butler matrix) for generating orthogonal radiation beams in which the phase changes linearly antenna by antenna. The Butler matrix is typically used to measure which beam receives the most signal energy, i.e. in which beam the signal is the strongest, and this beam is selected for the transmission.

In the linear case, the elements can be arranged so as to form a ULA (Uniform Linear Array), where the elements are in a straight line at equal distances. In the planar case, a CA (Circular Array), for example, can be formed, where the elements are on the same plane forming a circle circumference in the horizontal direction. In this case a certain sector of the circle is covered, e.g. 120 degrees or even the full circle, i.e. 360 degrees. In principle, the above-mentioned uniplanar antenna structures can also be implemented as two- or even three-dimensional structures. A two-dimensional structure is achieved, for example, by placing ULA structures next to one another, the elements thus forming a matrix. The antenna elements of the antenna array may also comprise several antenna units. For instance, in the case of a matrix-form antenna, the antenna element may refer to a matrix column of the matrix-form antenna.

By virtue of using constructive and destructive interference among antenna signals in directed beamforming it is usually important that an option to control phases and amplitudes is provided. Performance degradation because of noise, such as local oscillator (LO) or frequency synthesizer phase noise, inherent to the system takes place. An embodiment provides certain—common—system architectures with a possibility to turn the noise into a system performance improving quantity. This is typically achieved by, when transceiver noise sources are correlated, arranging the noise sources spatially, i.e. assigning them to different antenna array elements. This applies to both uplink and downlink.

Correlated noise appears in different transceiver signals for instance when a same LO or frequency synthesizer is used for two or more branches. The noise can then be arranged either by feeding the LO signal to different transceiver branches, or by connecting the final transmit/receive signal to different antenna elements.

It should be noticed that high order constellation modulation methods are typically used in multi-antenna systems. The performance of high order constellation modulation systems is especially sensitive to an increase of error vector magnitude.

An embodiment of the invention provides a possibility to decrease error vector magnitude (EVM) in a beam formed signal of an antenna array or in the main lobe of a beam formed signal, which then affects improvement in the performance of the system.

An embodiment enables a creation of a beamforming system where signals are easily decodable in a main lobe, but unreadable in side lobe regions by ensuring that noise (typically phase noise) is uncorrelated enough.

Further, an embodiment is usable in creating nulls in antenna beams. Nulls may be created by feeding local oscillator signal to antenna elements symmetrically.

Embodiments are thus especially well suited to multi-antenna beamforming systems which drive several branches by using a same local oscillator or other sources of noise (typically phase noise).

Determination of the error vector magnitude (EVM) will be described below with reference to FIG. 2. The EVM is typically used as an indicator for the quality of modulation and it is usually expressed as a percentage of signal energy.

FIG. 2 shows a simple example of a signal space diagram, which illustrates the location of modulated symbols with respect to one another.

In the example of FIG. 2, horizontal axis 200 shows a quadrature component of a modulated signal and vertical axis 202 shows an in-phase component. The example shows a two-dimensional signal space diagram of a phase-modulated signal when the modulation comprises four levels. The system thus employs four different signals or pulse forms. In the example of FIG. 2, points 204, 206, 208 and 210 denote different signals, or states of the signal space diagram. In the different states 204, 206, 208, 210 of the signal space diagram the phase difference of the signal varies. The number of the states in the signal space diagram varies in different modulation methods: the more states the greater the data transmission capacity of the system. As shown in FIG. 2, the signal space diagram can be illustrated as a unit circle, but other possible manners of representation also exist. Circles 212, 214, 216, 218 denote the area where the signals represented by different symbols are actually located due to different types of interference.

A signal space diagram is formed such that the pointer diagrams of the different signals with specified phase differences are placed in the same diagram. FIG. 2 shows one pointer diagram 220, which represents the amplitude of one signal. Angle 224 denotes the signal phase difference. The pointer diagram shown in the figure represents the signal Acos(2πf₀t+φ) wherein A is the signal amplitude, f₀ is the average frequency, t is time and φ is the phase difference.

An arrow 222 denotes a vector that represents the distance between an interference-free location of a symbol and its actual location. In this case the modulated signal comprises summed interference. This vector is called error vector magnitude (EVM).

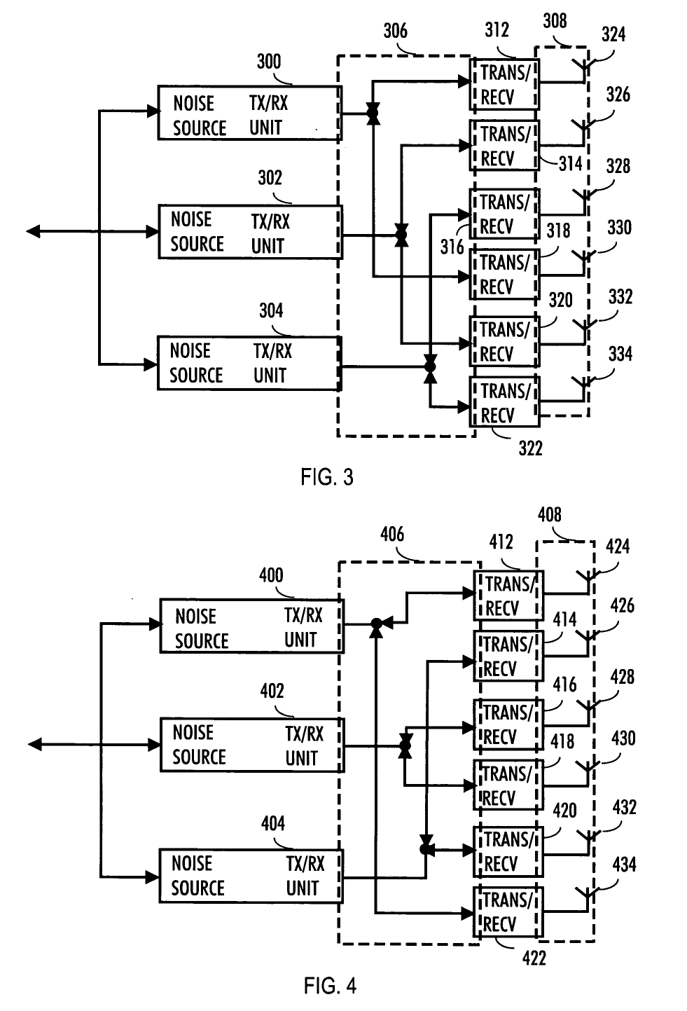

Some embodiments of an apparatus are explained by means of FIGS. 3 and 4.

An embodiment of an apparatus includes at least one generator configured to provide a plurality of signals comprising at least partially correlated noise and a circuitry configured to convey the signals comprising at least partially correlated noise to a plurality of nonadjacent antenna array elements. The conveying is typically carried out for ordering the signals in such a way that effects of noise are decreased.

An embodiment of an apparatus comprises means for providing a plurality of signals comprising at least partially correlated noise, and means for conveying the signals comprising at least partially correlated noise to a plurality of nonadjacent antenna array elements. The conveying is typically carried out for ordering the signals in such a way that effects of noise are decreased.

The signals comprising at least partially correlated noise typically include at least one of the following: signals to be transmitted, reception signals and signals from a noise source, such as a local oscillator signal.

The circuitry includes coupling of different units via any number or combination of intervening elements (indirect) or direct coupling, and also a merely functional relationship. Ordering typically means ordering connections between generators and antenna array elements. The ordering takes into account information on transmitter/receiver signals having correlated noise. Another manner of ordering is ordering local oscillator signals, since they are an important source of noise (typically phase noise). An apparatus according to an embodiment typically provides a plurality of local oscillator signals.

Another embodiment of an apparatus includes a circuitry for conveying the signals to be transmitted to nonadjacent antenna elements and/or for conveying the reception signals from nonadjacent antenna elements.

Yet another embodiment includes circuitry for conveying the signals to be transmitted also to one or more adjacent antenna elements and/or for conveying the reception signals also from one or more adjacent antenna elements.

Also an option for creating nulls in antenna beams by conveying the at least partially correlated noise signals to antenna elements symmetrically is provided.

Each apparatus may for instance be a part of a module carrying out signal reception and transmission. They may also be implemented as one or more chip sets.

Although the apparatus has been depicted as one entity, different modules may be implemented in one or more physical or logical entities.

The apparatus may be a mobile device, such as a portable computing device. Such computing devices include wireless mobile communication devices operating with or without a subscriber identification module (SIM), including, but not limited to, the following types of devices: mobile phone, handset, multimedia device, personal computer, game console, laptop (notebook), and personal digital assistant (PDA).

The apparatus may also be a node or a host.

Naturally, although the examples of FIGS. 3 and 4 are depicted by using transceivers, the transceivers may as well be transmitters and/or receivers when transmitters and receivers are not combined. FIGS. 3 and 4 depict embodiments of apparatuses (such as a module or chip set) or parts of apparatuses (such as a mobile device) depending on a current implementation. The number of transceivers/transmitters/receivers may vary according to implementation and they are not limited to what is depicted in FIGS. 3 and 4.

In the examples, transceiver/transmitter/receiver chains are driven in pairs.

FIG. 3 depicts an embodiment of an apparatus in a case no adjacent antenna array elements are used.

In practice, one possible implementation is to order signals between transceivers/transmitters/receivers and antenna array elements. Ordering is typically arranged to indicate branches affected by at least partly correlated noise. As an option, ordering of sources of at least partly correlated noise, such as local oscillators or frequency synthesizers, is presented.

The apparatus of FIG. 3 includes noise sources or transceiver/transmitter/receiver units 300, 302, 304 which generate noise signals (e.g. local oscillator signals cause phase noise) and/or signals to be transmitted or reception signals, the units typically including means for data processing.

The apparatus of FIG. 3 further provides six transceiver/transmitter/receiver chains 312, 314, 316, 318, 320, 322 fed by the transceiver/transmitter/receiver units or noise sources, the transceiver/transmitter/receiver chains including for instance radio frequency parts (filters, up/down converters, power amplifiers etc.). The apparatus of FIG. 3 also depicts antenna array elements 324-334.

As can be seen from FIG. 3, signals to be transmitted generated by transmitter units are conveyed to antenna array elements which are not adjacent to each other, noise signals generated by noise sources are also conveyed to or from antenna array elements which are not adjacent to each other, and reception signals are conveyed form antenna array elements by using arrangements 306, 308. Arrangements are typically implemented with one or more circuitry. The arrangements are shown in FIG. 3 by using dotted line boxes for the sake of clarity.

As can be seen from FIG. 3, all transmitter units/noise sources convey signals to transmitter chains and thus antenna array elements which are not adjacent to each other. Additionally, reception signals are conveyed from antenna array elements which are not adjacent to each other.

FIG. 4 depicts an embodiment wherein also adjacent antenna array elements are used. In practice, one possible implementation is to order signals between transceivers/transmitters/receivers and antenna array elements. Ordering is typically arranged to indicate branches affected by at least partly correlated noise. As an option, ordering of signals from sources of at least partly correlated noise, such as local oscillators or frequency synthesizers, is presented.

The apparatus of FIG. 4 includes noise sources or transceiver/transmitter/receiver units 400, 402, 404 which generate noise signals (e.g. local oscillator signals cause phase noise) and/or signals to be transmitted or reception signals, the units typically including means for data processing.

The apparatus of FIG. 4 further provides six transceiver/transmitter/receiver chains 412, 414, 416, 418, 420, 422 fed by the transceiver/transmitter/receiver units or noise sources, the transceiver/transmitter/receiver chains including for instance radio frequency parts (filters, up/down converters, power amplifiers etc.). The apparatus of FIG. 4 also depicts antenna array elements 424-434.

As can be seen from FIG. 4, two transceiver/transmitter/receiver units or noise sources convey signals to or from transceiver/transmitter/receiver chains 412, 414, 420, 422 and thus antenna array elements 424, 426, 432, 434 which are not adjacent to each other, and one conveys signals to or from transceiver/transmitter/receiver chains 416, 418 and thus adjacent antenna arrays 428, 430 by using arrangements 406, 408. The arrangements are typically implemented with one or more circuitry. The arrangements are shown in FIG. 4 by using dotted line boxes for the sake of clarity.

In the case of one dimensional antenna array, for a beam to which the Error Vector Magnitude is desired to be minimized or at least diminished in the strongest power (typically opposite to null steering), in a system including M correlated noise sources (such as oscillators) and N antennas, M and N being integers, one possible ordering (arranging) takes the form “1 2. . . M 1 2. . . M” (1=first oscillator, 2=second oscillator, M=number M oscillator) where the numbers indicate different oscillators and the position of the number indicates a transceiver branch.

Some possible orderings are:

TABLE 1

| Number | Uncorrelated noise sources | |
|---|---|---|
| of antennas | (e.g. local oscillators) | ordering |
| 4 | 2 | 1 2 1 2 |
| 6 | 3 | 1 2 3 1 2 3 |
| 8 | 2 | 1 2 1 2 1 2 1 2 |
| 8 | 4 | 1 2 3 4 1 2 3 4 |
| 10 | 5 | 1 2 3 4 5 1 2 3 4 5 |
| 12 | 3 | 1 2 3 4 1 2 3 4 1 2 3 4 |
| 16 | 4 | 1 2 3 4 1 2 3 4 1 2 3 4 1 2 3 4 |

Other kinds of ordering (arranging) are possible as well, such as “1 2. . . M M . . . 2 1”.

On the basis of simulations it is noticed that the best overall performance in the half power region is obtained by-using the translationally symmetric case (1 2 3 1 2 3).

A conjecture is that an arrangement with the greatest spatial separation between noise sources leads to the best performance. This is in line with a deduction made on the basis of simulations that a system with all branches having uncorrelated noise (typically phase noise) sources has better performance than one where all noise sources are correlated. In other words, as to the aspect of noise-induced EVM, a system where all transceivers are driven by the same LO has worse performance than one where every branch has its own LO.

Although the example is for a dimensional antenna array, the principles of arrangement are applicable also to multidimensional antenna arrays.

The arranging/ordering may also be controlled by software (controller not shown in the Figures for the sake of clarity). One possible implementation is that more array antenna elements are provided than necessary for transmission or reception. The control logic then controls the use of antenna array elements. In that case, the control logic typically controls the selection of antenna array elements to which at least partially correlated noise signals are conveyed. The selection is made for decreasing effects of noise.

The computer program may be in source code form, object code form, or in some intermediate form, and it may be stored in some sort of carrier or distribution medium, which may be any entity or device capable of carrying the program. Such carriers include a computer readable medium, program storage medium, record medium, computer memory, read-only memory, electrical carrier signal, telecommunications signal, and software distribution package, for example. Depending on the processing power needed, the computer program may be executed in a single electronic digital computer or it may be distributed amongst a number of computers. Next, an embodiment of a method will be described with reference to FIG. 5.

A failure to achieve a phase balance between antenna array elements may prohibit the highest possible performance gains obtainable by beamforming from being achieved. In such a case, the performance is typically decreased by noise introduced at oscillator or phase lock loop stages. Noise generated at transceivers (as well as at separate transmitters and/or receivers) usually causes variations in both beam power and the phase of the signal, thus decreasing the performance.

The embodiment starts in block 500. In block 502 a plurality of signals comprising at least partially correlated noise is generated. Examples of such signals are signals to be transmitted, reception signals and noise signals, such as local oscillator signals or frequency synthesizer signals. In block 504, the signals comprising at least partially correlated noise are conveyed to and/or from a plurality of nonadjacent antenna array elements. This is typically carried out for ordering the signals in such that effects of noise are decreased. The embodiment ends in block 506.

The embodiment may further include conveying the signals to be transmitted to nonadjacent antenna elements and/or conveyance the reception signals from nonadjacent antenna elements. The conveying may be carried out for ordering the signals in such that effects of noise are decreased.

Further, conveyance the signals to be transmitted also to adjacent antenna elements and/or conveying the reception signals also from adjacent antenna elements is possible. The embodiment may also include controlling the selection of antenna array elements for use for decreasing effects of noise (typically phase noise) if more antenna array elements than necessary are provided for transmission or reception.

Further, an option for creating nulls in antenna beams by conveying the at least partially correlated noise signals to antenna elements symmetrically is provided.

The embodiment is repeatable. An arrow 508 depicts one option for repetition.

The steps/points, signalling messages and related functions described in FIG. 5 are in no absolute chronological order, and some of the steps/points may be performed simultaneously or in an order different from the given one. Other functions can also be executed between the steps/points or within the steps/points and other signalling messages sent between the illustrated messages. Some of the steps/points or part of the steps/points can also be left out or replaced by a corresponding step/point or part of the step/point.

Simulations show that the order by which the local oscillators are operationally coupled to antenna elements clearly affect the performance of the system. Coupling antenna elements operationally adjacently (e.g. 11 . . . 22 . . . 33 . . . ) typically gives remarkably poor results in comparison to the translationally symmetric operational coupling (e.g. 123 . . . 123 . . . ).

Different orderings usually also affect side lobe levels as well as depth of minimums.

Another interesting result is that with uncorrelated noise (typically phase noise) EVM is smaller than with correlated noise near the beam maximum. Beam maximums are typically intended for signal transmission and/or reception. The directions in which the power is smaller mainly act as interference to other beams or other radio systems. Thus, introducing independent noise (typically phase noise) actually makes the lower power regions more noise like which may be useful when confidential data is transmitted and in the cases it is important that only selected receivers (located at a correct angle) are able to receive the data.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, implementation can be through modules of at least one chip set (e.g., procedures, functions, and so on) that perform the functions described herein. The software codes may be stored in a memory unit and executed by processors. The memory unit may be implemented within the processor or external to the processor. In the latter case it can be communicatively coupled to the processor via various means as is known in the art. Additionally, components of systems described herein may be rearranged and/or complimented by additional components in order to facilitate achieving the various aspects, etc., described with regard thereto, and they are not limited to the precise configurations set forth in given Figures, as will be appreciated by one skilled in the art.

It will be obvious to a person skilled in the art that, as technology advances, the inventive concept can be implemented in various ways. The invention and its embodiments are not limited to the examples described above but may vary within the scope of the claims.

1. An apparatus, comprising:
a generator configured to provide a plurality of signals comprising at least partially correlated noise; and
a circuitry configured to convey the signals comprising at least partially correlated noise to a plurality of nonadjacent antenna array elements.

2. The apparatus of claim 1, wherein the circuitry is further configured to convey the signals comprising at least partially correlated noise to a plurality of nonadjacent antenna array elements to order the signals to decrease effects of noise.

3. The apparatus of claim 1, wherein the at least one generator is further configured to provide signals to be transmitted.

4. The apparatus of claim 1, wherein the at least one generator is a noise source.

5. The apparatus of claim 1, wherein the generator is further configured to provide reception signals.

6. The apparatus of claim 1, wherein the circuitry is further configured to convey the signals to be transmitted to nonadjacent antenna elements and/or to convey the reception signals from nonadjacent antenna elements.

7. The apparatus of claim 1, wherein the circuitry is further configured to convey the signals to be transmitted to adjacent antenna elements and/or to convey the reception signals from adjacent antenna elements.

8. The apparatus of claim 1, wherein the apparatus is further configured to decrease the effects of noise by decreasing error vector magnitude in a beam formed signal.

9. The apparatus of claim 1, wherein the generator is a noise source and the noise source is a local oscillator or a frequency synthesizer.

10. The apparatus of claim 1, further comprising:
a controller configured to select antenna array elements to use to decrease the effects of noise if more array antenna elements than necessary are provided for transmission or reception.

11. The apparatus claim 1, wherein the circuitry is further configured to create nulls in antenna array beams by conveying the signals comprising at least partially correlated noise to antenna array elements symmetrically.

12. The apparatus of claim 1, wherein the apparatus comprises a module.

13. The apparatus of claim 1, wherein the apparatus comprises a chip set.

14. A method, comprising:
providing a plurality of signals comprising at least partially correlated noise; and
conveying the signals comprising at least partially correlated noise to a plurality of nonadjacent antenna array elements.

15. The method of claim 14, further comprising:
conveying the signals comprising at least partially correlated noise to a plurality of nonadjacent antenna array elements to order the signals to decrease effects of noise.

16. The method of claim 14, further comprising:
providing signals to be transmitted.

17. The method of claim 14, further comprising:
providing reception signals.

18. The method of claim 14, further comprising:
providing noise source signals.

19. The method of claim 14, further comprising:
conveying the signals to be transmitted to nonadjacent antenna elements and/or conveying the reception signals from nonadjacent antenna elements.

20. The method of claim 14, further comprising:
conveying the signals to be transmitted to adjacent antenna elements and/or conveying the reception signals from adjacent antenna elements.

21. The method of claim 14, further comprising:
decreasing the effects of noise by decreasing error vector magnitude in a beam formed signal.

22. The method of claim 14, further comprising:
controlling the selection of antenna array elements to use to decrease the effects of noise if more antenna array elements than necessary are provided for transmission or reception.

23. The method of claim 14, further comprising:
creating nulls in antenna beams by conveying the at least partially correlated noise signals to antenna array elements symmetrically.

24. An apparatus, comprising:
means for providing a plurality of signals comprising at least partially correlated noise; and
means for conveying the signals comprising at least partially correlated noise to a plurality of nonadjacent antenna array elements.

25. A computer program product encoding a computer program of instructions for executing a computer process, the process comprising:
controlling selection of antenna array elements to which signals comprising at least partially correlated noise are conveyed if more antenna array elements than necessary are provided for transmission or reception, the selection being made for decreasing effects of noise.

26. A computer program distribution medium readable by a computer and encoding a computer program of instructions for executing a computer process, the process comprising:
controlling selection of antenna array elements to which signals comprising at least partially correlated noise are conveyed if more antenna array elements than necessary for transmission or reception, the selection being made for decreasing effects of noise.

27. The computer program distribution medium of claim 26, the distribution medium including at least one of the following media: a computer readable medium, program storage medium, record medium, computer memory, read-only memory, electrical carrier signal, telecommunications signal, and software distribution package.
